(19) United States
(12) Patent Application Publication
(10) Pub. No.: US 2010/0230962 A1
(43) Pub. Date: Sep. 16, 2010

(54) SELF-ALIGNING FLANGED JOINT AND ALIGNMENT RIM THEREFOR

(75) Inventor: Louis Charles BONGIORNO, Millington, NJ (US)

Correspondence Address: SCULLY SCOTT MURPHY & PRESSER, PC, 400 GARDEN CITY PLAZA, SUITE 300, GARDEN CITY, NY, 11530, US

(73) Assignee: FLOWSMART, INC., Seaford, DE (US)

(21) Appl. No.: 12/633,446

(22) Filed: Dec. 8, 2009

Related U.S. Application Data
(60) Provisional application No. 61/120,511, filed on Dec. 8, 2008.

(51) Int. Cl. F16L 23/00; F16L 17/00; F16J 15/06

(52) U.S. Cl. 285/363; 277/626; 277/627

(57) ABSTRACT

The invention discloses a gasket assembly and a flanged joint system comprising a sealing member, a retaining ring having an outer periphery and an inner periphery wherein said inside periphery being coupled to said sealing member, and an alignment rim that is disposed outwardly from the outer periphery of said retaining ring, but only extends continuously along a portion of said outer periphery, the remainder of the periphery being open to facilitate placement between piping flanges.

### CROSS-REFERENCE TO RELATED APPLICATION

This application claims the benefit of U.S. Provisional Application No. 61/120,511 filed on Dec. 8, 2008.

### FIELD OF THE INVENTION

The invention relates to the joining of tubes or pipes, and more particularly, to an aseptic flanged joint. The joint is self-aligning by virtue of a retaining ring that has an alignment rim extending outwardly and continuously around a portion only of the outer circumference of the ring. That portion of the ring not comprising the alignment rim is thus easily disposed between the joint, by e.g. slipping it between same, without necessitating the dismantling of all or part of the assembly or the undue prying apart of the terminal flanges; whereas that portion of the ring comprising the rim secures and aligns the joint. In select embodiments, the alignment rim extends over about one half of the retaining ring outer circumference while the other half of the retaining ring remains open, i.e. lacks the rim.

### DESCRIPTION OF THE PRIOR ART

Flanged joints are widely used to interconnect tubes or pipes conveying a variety of fluids, including gases, liquids, liquids also containing solid or semi-solid matter, or other fluid-like media. The tubes may be either pressurized or under vacuum. The joints connect extended sections of tubes, as well as joining tubes to fittings, couplers, valves, pumps, inspection ports, and other related devices. An ideal joint is easily assembled with minimal cost and labor, and is capable of operating reliably under any conditions reasonably anticipated during its service life. It is essential that the joint remain sealed to prevent leakage either into or out of the system in which the tube is used. The materials comprised in the joint must be chemically and thermally compatible under operating conditions with substances they will contact and the surfaces of the joint fittings. In many cases, it is further required that the joint be easily disassembled for repair and maintenance operations, including the cleaning and sanitizing of systems and replacement of gaskets or the like. Ideally, the presence of the joint does not introduce any protrusion or other interruption of the uniform surface inside the piping that would increase the flow resistance of the piping, e.g. by disrupting or impeding the smooth flow of fluid therethrough.

The requirements for joints, including flanged joints, used in process systems that convey food, beverage, pharmaceutical, personal care, or other like products intended for human or animal use through ingestion or external application are especially demanding. These systems must be maintained under strictly aseptic conditions. As used herein and in the subjoined claims with reference to a process system, the term “aseptic condition” is understood to mean a condition in which there is substantially no growth of unwanted or pathogenic organisms and substantially no buildup of debris or other medium in which such organisms are likely to reproduce or be trapped, agglomerated, concentrated, or otherwise situated in a manner that is likely to contaminate any substance passing through the system. The term “aseptic product” is to be understood as referring to any of the aforementioned products that ordinarily must be processed under aseptic conditions. Moreover, no materials can be used in aseptic joint systems that would introduce any harmful or objectionable substances into the process stream for the aforementioned aseptic products. Many piping and joint systems that might be acceptable for general chemical or industrial processing are not able to satisfy one or more of the stringent requirements associated with processing aseptic products. For example, some known joint systems have a configuration wherein recesses, crevasses, O-ring grooves, or the like result in dead spaces or stagnation regions in which there is little or no flow of the fluid being transported. As a result, accumulation of debris likely to give rise to the accumulation and reproduction of pathogens is a serious concern. Also, some known gasket materials may impart objectionable flavors or even toxic substances into food, beverages, or pharmaceuticals. Furthermore, the use of certain substances that come into contact with the process fluid may be offensive to adherents of certain religious traditions.

A variety of techniques are in widespread use for making interconnections. Flanged joints employing deformable gasket material that is interposed between the flanges and deformed by axial compression between the flanges are commonly used. Various materials have been used for such gaskets, such as elastomeric materials, impregnated fibrous materials, and soft metal sheets. One form of such joint and seal is depicted generally at 9 in FIG. 1. Joint 9 connects generally cylindrical tubes 12, 14, which are attached to flanges 6, 8 (also known as ferrules) by welding 11, as shown, or by various other known techniques. Flanges 6 and 8 adjoin in end-to-end relationship about a common center axis 19. The flanges are substantially identical and have mating faces generally perpendicular to axis 19. Opposite the mating face of each flange is a clamping face including tapered section 36. When flanges 6 and 8 are mated, respective sections 36 cooperate to form a generally frustoconical peripheral surface. The joint is secured using clamp 40 and sealed using O-ring gasket 17. The flanges used on each side of joint 9 are substantially identical in shape.

The mating face surface of flanges 6 and 8 has an inner portion 30 and an outer portion 34 that are generally co-planar, along with an intermediate circumferential groove or recess 32 that accommodates gasket 17, which is in the form of a synthetic rubber O-ring, i.e. a cylindrical gasket having the shape of a torus or donut. The O-ring is located and received in grooves 32. Normally flanges 6 and 8 both include a groove 32. However, joints are sometimes used in which a groove is provided in only one of the flanges, the other flange having a fully planar mating surface. Of course, the groove in such embodiments must be correspondingly deeper. In other instances, the gasket is a cylindrical O-ring with a rectangular cross-section (not shown) instead of the more commonly used circular cross-section.

Joint 9 is secured with a split-ring clamp 40, which is ordinarily composed of metal. A major portion of the inner circumferential surface of clamp 40 has a V-shape with tapered surface portions 42. These tapered surfaces encircle and securingly engage correspondingly tapered outer sections 36 of flanges 6 and 8. Clamp 40 is split into a plurality of arc-like segments. As further illustrated in the form depicted in FIG. 2, clamp 40 has two generally semicircular arc segments 50, 52, each subtending an angle slightly less than 180°. Segments 50 and 52 are both bifurcated at each of their ends. A rigid linkage 54 joins ends 51 and 53 of segments 50 and 52, respectively, and is disposed between the furcations. Retaining pins 55 pass through and are secured in holes in ends 51 and 53. Pins 55 also pass freely through holes in opposite ends of linkage 54 to create rotatable joints between the segments 50, 52 and linkage 54, allowing segments 50 and 52 to pivot about pin 55 within a common plane. The opposite ends of segments 50 and 52 have enlarged, furcated ends 58 and 59, respectively. A retaining pin 62 passes through and is secured in holes in end 59. Pin 62 also passes freely through the eye of threaded eyebolt 60, which is located between the furcations of end 59. To secure the clamp, the free end of eyebolt 60 is rotated about pin 62 and into the space between the furcations of end 58. A threaded nut 64 is tightened onto eyebolt 60 and against a flat surface of furcated end 58 to place clamp 40 in closed position, as shown in FIG. 2.

The tightening of nut 64 acts to reduce the effective circumference of clamp 40. The resulting wedging of frustoconically tapered inner clamp surface 42 over opposed, complementary frustoconical sections 36 of the two flanges imparts an axially directed force urging the flanges together. Proper design of joint 9 requires that the degree of tightening clamp 40 that brings corresponding surfaces 30 and 34 of flanges 6 and 8 into contact causes a requisite degree of compression of O-ring 17. Proper sealing is effected if O-ring 17 substantially fills grooves 32 of both flanges, with contact between O-ring 17 and grooves 32 on each side that extends around the full circumference of each flange.

However, in practice a number of problems occur in reliably effecting seals using joints of the type depicted by FIG. 1. Ideally, both the application of clamp 40 depicted in FIG. 1 and the full seating of O-ring 17 in respective facing grooves 32 provide the required lateral alignment of the opposed flanges. At best, O-ring 17 provides only minimal lateral alignment of respective grooves 32. It is frequently found that joints are made up with the flanges not fully coaxially aligned. As a result, the corresponding grooves 32 in the two flanges are not aligned and O-ring 17 often is not fully and properly seated in both grooves 32. In this circumstance, tightening of clamp 40 may compress at least part of O-ring 17 between surfaces 30 or 34. Damage to the O-ring is likely, especially in parts that traverse the edges between groove 32 and the adjacent planar surfaces 30 or 34. Premature failure of the O-ring to seal commonly results. Moreover, surfaces 30 and 34 may not properly seat in this situation, in many cases creating a recess between surfaces 30 into which process fluid present in tubes 12 and 14 can collect. In some cases such a recess communicates with portions of groove 32 not filled with O-ring 17, increasing the likelihood of untoward consequences, such as microbial activity as described in detail above. A joint system that more positively assures proper alignment and a durable, effective seal is thus highly sought.

Moreover, even if the flanges are accurately aligned and the O-ring seal properly disposed in its grooves, the joint system of FIGS. 1-2 is prone to certain difficulties. The axial impingement of the mating flanges after the clamp is secured is limited by metal-to-metal contact of the flange faces. In some cases, especially after wear and tear that attends repeated assembly and disassembly of the flanged joint, contact occurs in regions 34, leaving some space between facing inner surface regions 30. Frequently, such an area becomes a trap, with the deleterious consequences set forth above.

In many applications, O-ring 17 must be replaced periodically. In some industrial manufacturing processes, required system repairs or periodic preventive maintenance dictate that flanged joints be disassembled and reassembled frequently. Exposure to required processing temperatures or to corrosive or abrasive process fluids in some cases causes seal materials to erode. Some materials are embrittled over time by exposure to their process environment. Moreover, many seal materials exhibit creep or related mechanical phenomena or otherwise lose their elasticity and take a permanent “set.” Joints that are clamped together repeatedly despite poor alignment also are likely to result in wear or damage (e.g. scratching) to mating surfaces 30, 34, which may also compromise seal integrity. Cleaning and sanitary protocols demand regular service of joints and replacement of seals in still other instances. The actual cost of the O-ring and other elastomeric components typically is small in comparison with the labor costs for their replacement and the losses due to manufacturing downtime. However, the metal parts of the joint are generally far more expensive due to the precision machining and dimensional control needed. As a result, it is highly desired that metal parts be reusable.

Solutions to the aforesaid have included gaskets having gripping means to keep them in place while the assembly of clamp 40 is completed. One such means involves a retaining ring having an alignment rim that extends outwardly around the entire 360° circumference of the ring. An embodiment of this design is disclosed in U.S. Pat. No. 7,350,833, the entire contents of which are incorporated herein by reference. Another example of gripping means in this regard is described in US Published Patent Application 2007/0045968 A1. The pipe gasket described therein has a support element having at least two protrusions, preferably three, disposed equidistant along the outer circumference. Notwithstanding these developments, there are instances when limited access to the piping because of close quarters and the like require extra manipulations to install these designs, including the dismantling of the joint or the prying apart and spreading open of mating surfaces 30 and 34 to properly position the assembly about the axis 19.

Improvements to configurations known heretofore for flanged joints are thus desired to, e.g. allow for easier installation and alignment in close spaces and by minimizing the need for dismantling or prying apart of the joint.

### SUMMARY OF THE INVENTION

In one embodiment, the invention is to a gasket assembly comprising (a) a sealing member (e.g. an O-ring); (b) a retaining ring having an outer periphery and an inner periphery, said inside periphery being coupled to said sealing member; and (c) an alignment rim disposed outwardly from the outer periphery of said retaining ring and extending continuously along only a portion of said outer periphery.

In another embodiment, the invention provides a flanged joint system for aseptically connecting first and second pipes disposed along a common axis. A first flange terminates the first pipe and a second flange terminates the second pipe. The flanges are generally circular and have a flange outside diameter and a mating surface that optionally includes a circumferential flange groove therein. The pipes are oriented such that the mating surfaces are substantially perpendicular to the common axis and in facing, parallel relationship. A gasket assembly is interposed between the flanges and aligned in mutually coaxial relationship. The gasket assembly comprises: (i) an outer annular, substantially rigid retaining ring having opposed axial surfaces that abut at least a portion of the flanges' mating surfaces; a single, continuous alignment rim that partially encircles an outside periphery of the ring, the alignment rim extending axially from each of said axial surfaces, the portion of the retaining ring not comprising the alignment rim (also referred to as the “open” portion of said ring) being sized sufficient to slide into place from e.g. the side of the pipe flanges without spreading said flanges apart; a retaining shoulder projecting radially inward; and a retaining shoulder projecting radially inward; and (ii) an inner deformable annular sealing member having a radially inner annular portion having a rectangular cross-section and sealing surfaces on the axial sides of the rectangular portion; and an encircling sealing shoulder portion that projects radially outward. The alignment rim is sized to slippably receive the outside diameter of the flanges on opposite sides of the retaining ring. The sealing shoulder portion is shaped to receive the retaining shoulder and is removably engaged therewith. The gasket assembly is aligned coaxially with the flanges by receipt of the flange outside diameters within the alignment rim. The joint is secured by a clamp means, such as a split-ring clamp, that urges the flanges together axially. The compression of the deformable annular sealing member is restricted to a preselected extent by abutment of the axial surfaces of the retaining ring with the mating surfaces of the flanges.

In another aspect, the invention provides a method for assembling a flanged joint connecting first and second pipes disposed along a common axis. The method comprises: (i) providing a first flange terminating the first pipe and a second flange terminating the second pipe, the flanges being generally circular and having a flange outside diameter and a mating surface; (ii) providing a gasket assembly; (iii) orienting the flanges such that the mating surfaces are substantially perpendicular to the common axis and in facing, parallel relationship; (iv) interposing the gasket assembly between the flanges; and (v) clamping the flanges together axially. The gasket assembly comprises an outer annular, substantially rigid retaining ring and an inner deformable annular sealing member. The retaining ring has an open portion that allows it to slide into place and an alignment rim portion that partly encircles, attaching to the outside periphery of the ring and extending axially from each of said axial surfaces, and a retaining shoulder projecting radially inward. The alignment rim is sized to slippably receive the outside diameter of the flanges on opposite sides of the retaining ring. The sealing member has a radially inner annular portion having a rectangular cross-section and sealing surfaces on the opposed axial sides of the rectangular portion and an encircling sealing shoulder portion that projects radially outward, said sealing shoulder portion being shaped to receive said retaining shoulder and being removably engaged therewith. The alignment rim is sized to slippably receive the outside diameter of the flanges on opposite sides of the retaining ring. Alignment of the flanges and the gasket assembly in mutually coaxial relationship is effected by receipt of the outside diameters of the flanges within the alignment ring. The clamping of the flanges axially compresses the deformable annular sealing member to a preselected extent, the compression being restricted by abutment of the respective axial surfaces of the retaining ring and the mating surfaces of the flanges.

In another aspect, the invention provides a method for assembling a flanged joint connecting first and second pipes disposed along a common axis. The method comprises: (i) providing a first flange terminating the first pipe and a second flange terminating the second pipe, the flanges being generally circular and having a flange outside diameter and a mating surface; (ii) providing a gasket assembly; (iii) orienting the flanges such that the mating surfaces are substantially perpendicular to the common axis and in facing, parallel relationship; (iv) interposing the gasket assembly between the flanges; and (v) clamping the flanges together axially. The gasket assembly comprises an outer annular, substantially rigid retaining ring and an inner deformable annular sealing member. The retaining ring has an alignment rim portion partly encircling and attaching to the outside periphery of the pipe flanges and extending axially from each of said axial surfaces, and an open portion configured to allow the ring to slide into place, and a series of holes located around its axis. The sealing member is molded through the series of holes completely around the retaining ring. Alignment of the flanges and the gasket assembly in mutually coaxial relationship is effected by receipt of the outside diameters of the flanges within the alignment rim. The open portion of the retaining ring is configured to enable an operator to slide the assembly past the pipe flanges without undue spreading of said flanges. The open portion is sized sufficient to allow for slide-by installation, whereas the alignment rim portion is sized sufficient to cause alignment and attaching onto the pipe flanges. The clamping of the flanges axially compresses the deformable annular sealing member to a preselected extent, the compression being restricted by abutment of the respective axial surfaces of the retaining ring and the mating surfaces of the flanges.

In another aspect, the invention provides a method for assembling a flanged joint connecting first and second pipes disposed along a common axis. The method comprises: (i) providing a first flange terminating the first pipe and a second flange terminating the second pipe, the flanges being generally circular and having a flange outside diameter and a mating surface; (ii) providing a gasket assembly; (iii) orienting the flanges such that the mating surfaces are substantially perpendicular to the common axis and in facing, parallel relationship; (iv) interposing the gasket assembly between the flanges; and (v) clamping the flanges together axially. The gasket assembly comprises an outer annular, substantially rigid retaining ring and an intermediately located deformable cushioning member and an inner annular sealing member that will be less compressible than the intermediate deformable cushioning member. The inner annular sealing member is sufficiently rigid to resist displacement during assembly and is preferably comprised of materials having greater chemical and steam resistance than the cushioning member, such as fluorinated polymers, including Teflon®, e.g. PTFE and the like. The cushioning member displaces more readily than the sealing member enabling improved sealing performance than attainable without use of the cushioning member The cushioning member preferably improves the memory of inner sealing member thereby improving the life of the seal. It also causes the inner annular sealing member (the inner annular sealing member is also referred to herein as “rigid seal”) to act more flexibly to create improved sealing properties. The retaining ring has an open portion that allows for sliding into place, and an alignment rim portion extending axially from each of said axial surfaces that partly encircles the retaining ring and is configured to attach to the outside periphery of the pipe flanges, and a series of holes located around its axis. The sealing member is molded through the series of holes completely around the retaining ring. Alignment of the flanges and the gasket assembly in mutually coaxial relationship is effected by receipt of the outside diameters of the flanges within the alignment ring. The open portion of the retaining ring being configured to enable an operator to slide the assembly past the pipe flanges without undue spreading said flanges. The open portion is sized sufficient to allow for slide-by installation, whereas the alignment rim portion is sized sufficient to cause alignment and attaching onto the pipe flanges. The clamping of the flanges axially compresses the deformable annular sealing member to a preselected extent, the compression being restricted by abutment of the respective axial surfaces of the retaining ring and the mating surfaces of the flanges.

In another aspect, the invention provides a method for assembling a flanged joint connecting first and second pipes disposed along a common axis. The method comprises: (i) providing a first flange terminating the first pipe and a second flange terminating the second pipe, the flanges being generally circular and having a flange outside diameter and a mating surface; (ii) providing a gasket of one material; (iii) orienting the flanges such that the mating surfaces are substantially perpendicular to the common axis and in facing, parallel relationship; (iv) interposing the gasket assembly between the flanges; and (v) clamping the flanges together axially. In this embodiment the retaining ring and the gasket are one in the same; i.e. the gasket itself is shaped such that it comprises an alignment rim portion and an open portion as herein described contiguous with the deformable sealing member, all formed as a unitary piece. Thus in this embodiment, the composition of the gasket is continuous from the outer periphery where the open portion and alignment rim portions are, to the inner diameter and is sufficient to affect a seal of the piping assembly without introducing a second or third material. The open portion of the gasket here is configured to enable an operator to slide the assembly past the pipe flanges without undue spreading said flanges. The open portion is sized sufficient to allow for slide-by installation, whereas the alignment rim portion of the gasket is sized sufficient to cause alignment and attaching onto the pipe flanges. The clamping of the flanges axially compresses the deformable annular sealing member to a preselected extent, the compression being restricted by abutment of the respective axial surfaces of the retaining ring and the mating surfaces of the flanges.

The use of the substantially rigid outer retaining ring in the gasket assembly limits the axial impingement of the flanges, thereby insuring that a preselected, proper degree of compression of the deformable portion of the gasket assembly is achieved. Excessive tightening, which frequently causes undesirable extrusion and possible removal of deformable gasket material into the bore of the joint assembly, is effectively prevented. Misalignment or misplacement of the gasket assembly within the flange joint is likewise minimized.

The present flange joint system virtually eliminates the formation of traps in recesses of the joint in which process fluid can collect or stagnate, which frequently leads to the presence or growth of harmful microbes or other pathogenic organisms. The joint is easily assembled and disassembled to permit servicing, including replacement of the gasket assembly. The separability of the sealing member and the retaining ring of the gasket permit the former to be replaced and the latter, which is ordinarily more expensive to manufacture, to be reused. The joint is reliable and durable. The servicing can be carried out expeditiously by personnel who need not have a high level of skill, thereby lessening maintenance costs and manufacturing downtime.

### BRIEF DESCRIPTION OF THE DRAWINGS

The invention will be more fully understood and further advantages will become apparent when reference is had to the following detailed description of the various embodiments of the invention and the accompanying drawings, wherein like reference numerals denote similar elements throughout the several views, and in which:

FIG. 1 is a cross-sectional view depicting a prior art flanged joint connecting two pipes disposed along a common axis, with the cross section being taken along a common diametrical plane of the pipes.

FIG. 2 is a plan view showing in greater detail the clamp used to secure the flanges joined to form the sealed joint depicted by FIG. 1, the cross-section of the clamp seen in FIG. 1 having been taken at level I-I.

FIG. 3A is a cross-sectional view depicting a flanged joint system of the invention connecting two pipes disposed along a common axis, with the cross section being taken along a common diametrical plane of the pipes.

FIG. 3B is a perspective view of the general configuration of the retaining ring of the invention showing the alignment rim portion and the open portion of the ring.

FIGS. 4A-4G are enlarged, cross-sectional views of various gasket assemblies of the invention showing alignment rim and an open portion wherein for each assembly the retaining ring is engaged with a radially inner sealing member, the different views showing different forms of engagement:

FIG. 4A shows a rectangular step engagement.

FIG. 4B shows a multiple angulated step engagement.

FIG. 4C shows a singly angulated step engagement.

FIG. 4D shows a mechanically locked seal engagement with an alignment rim portion that is “T” shaped in profile for interfacing with both pipe flanges.

FIG. 4E shows a mechanically locked seal engagement similar to FIG. 4D but with an alignment rim portion that is “L” shaped in profile for interfacing with one pipe flange.

FIG. 4F shows a mechanically locked seal engagement with an alignment rim portion that is “T” shaped in profile for interfacing with both pipe flanges and an intermediate cushioning member and a rigid seal surface located at the inside diameter.

FIG. 4G shows a mechanically locked seal engagement with an alignment rim portion that is “L” shaped in profile for interfacing with one pipe flange and an intermediate cushioning member and a rigid seal surface located at the inside diameter.

FIG. 4H shows a mortise and tenon engagement for the retaining ring and seal.

FIG. 4I shows a mortise and tenon engagement with an alignment rim portion that is “T” shaped in profile for interfacing with both pipe flanges and with an open portion that includes a replaceable seal that has a rigid seal surface that is supported by a compressible intermediate elastomeric cushioning member.

FIG. 4J shows a mortise and tenon engagement with an alignment rim portion that is “L” shaped in profile for interfacing with one pipe flange and with an open portion that includes a replaceable seal that has a rigid seal surface that is supported by a compressible intermediate elastomeric cushioning member.

FIG. 4K shows a gasket comprised of a single material of construction, rigid or elastomeric, and having a unitary configuration including continuous rim with an alignment rim portion (here shown as “L” shaped in profile for interfacing with one pipe flange) and with an open portion.

FIG. 5 is a cross-sectional view depicting a flanged joint system of the invention connecting two pipes disposed along a common axis, with the cross section being taken along a common diametrical plane of the pipes.

FIG. 6. is a cross-sectional view depicting the invention wherein the open portion of the retaining ring is slid between the pipe flanges without the need to spread apart the pipe flanges.

### DETAILED DESCRIPTION OF THE PREFERRED EMBODIMENTS

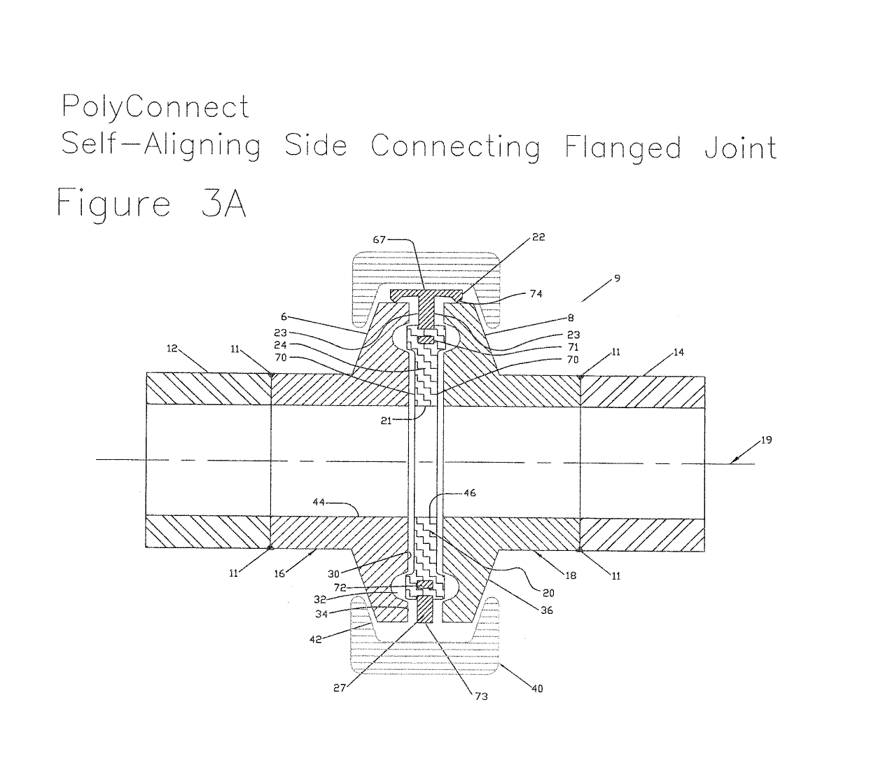

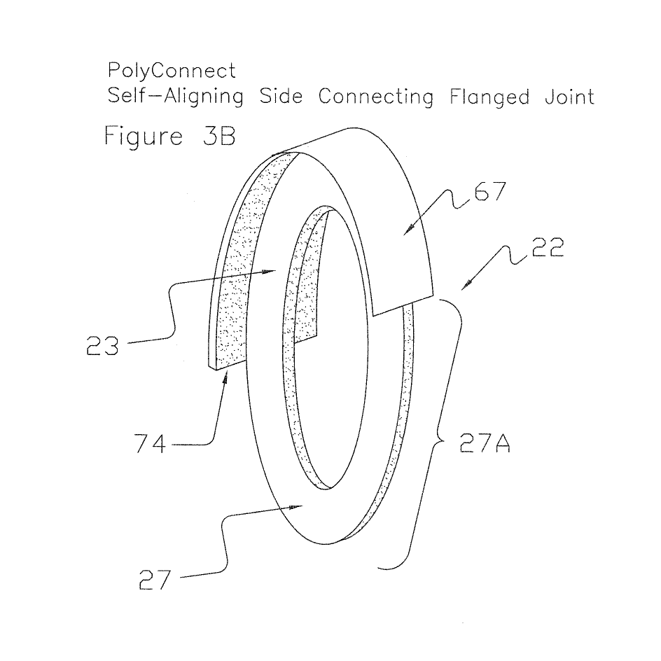

Referring to FIG. 3A there is depicted an embodiment of a flanged joint system of the invention. Joint 9 connects generally first and second cylindrical tubes 12, 14, which are welded 11 to first and second flanges 16, 18 (also known as ferrules). The terms “tube” and “pipe” are used herein throughout interchangeably and synonymously. Alternatively, the tubes may be attached by any other suitable method, non-exclusively including brazing, soldering, threaded connection, or any other similar technique that provides a durable, leak-resistant connection. Flanges 16 and 18 adjoin in end-to-end relationship about a common center axis 19. The flanges are substantially identical and have mating surfaces generally perpendicular to axis 19. Opposite the mating surfaces are clamping surfaces that include tapered portions 36, which cooperate to form a generally frustoconical outer peripheral surface when the flanges are juxtaposed. The joint is sealed using gasket assembly 20, which comprises a generally annular, rigid retaining ring 22 that is removably engaged with deformable annular sealing member 21. The mating surfaces of flanges 16 and 18 have an annular inner portion 30, an outer portion 34, and optionally an intermediate circumferential groove or recess (not shown). Surface portions 30 and 34 are generally flat and coplanar.

Retaining ring 22 can have either opposed axial surfaces 23, along with alignment rim 67 that encircles a portion of the ring's outer periphery and extends axially from each of its axial surfaces 23. Or it can have one sided axial surfaces 76. Alignment rim 67 is sized to slippably receive flanges 16 and 18. Notably, retaining ring 22 has an open portion, generally at 73, i.e. ring 22 has a portion that does not comprise alignment rim 67. This is very generally represented at FIG. 3B wherein ring 22 is shown having alignment rim 67 encircling roughly half of the outer periphery. The open portion is generally denominated as 27A (generally corresponding to 73 in FIG. 3A). It is this portion 27A that slips between the flanges during assembly, other details and features of the open area not be illustrated. In one embodiment, open area 27A comprises about 40 to about 60% of the outer periphery of ring 22; more preferably about 45 to about 55%; still more preferably about 49 to about 50% of the periphery is open. For these practices, it will be appreciated that alignment rim 67 takes up the remaining percentage of the periphery in a continuous fashion. In one embodiment, the retaining ring has a substantially cross sectional thickness from its inner to its outer periphery (the retaining ring thickness); preferably, the open portion of the retaining ring is of a thickness substantially equal to the retaining ring thickness.

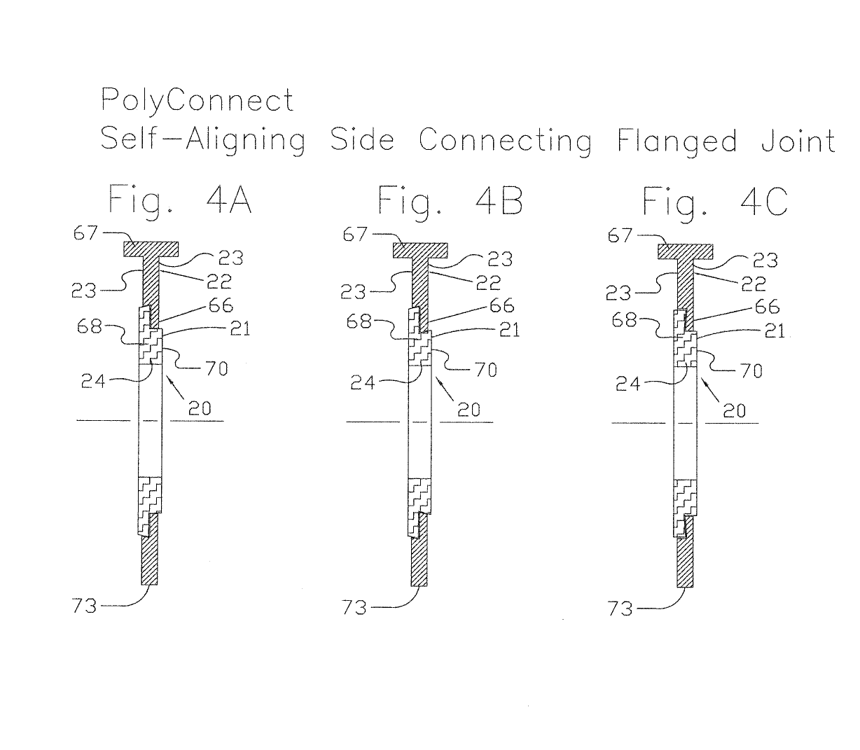

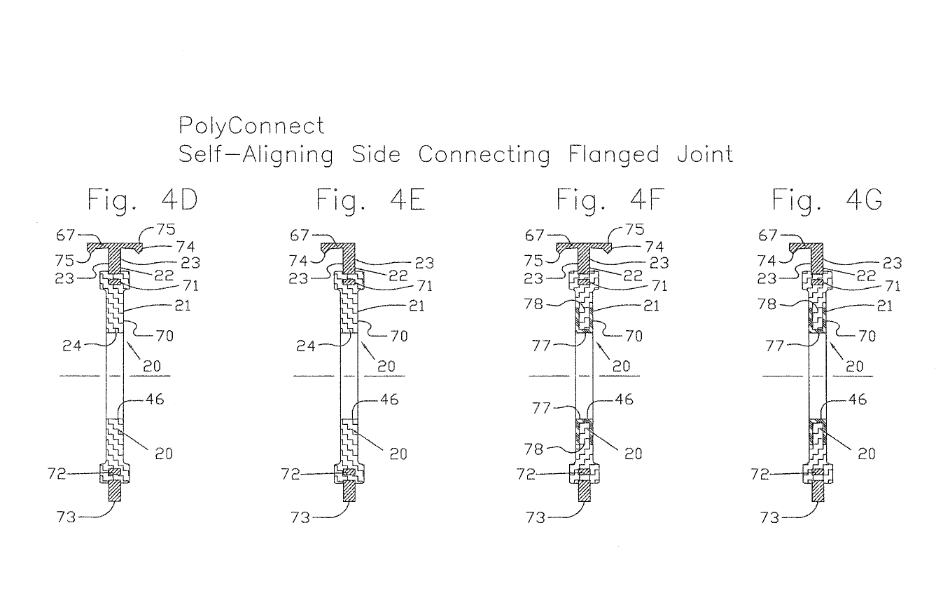

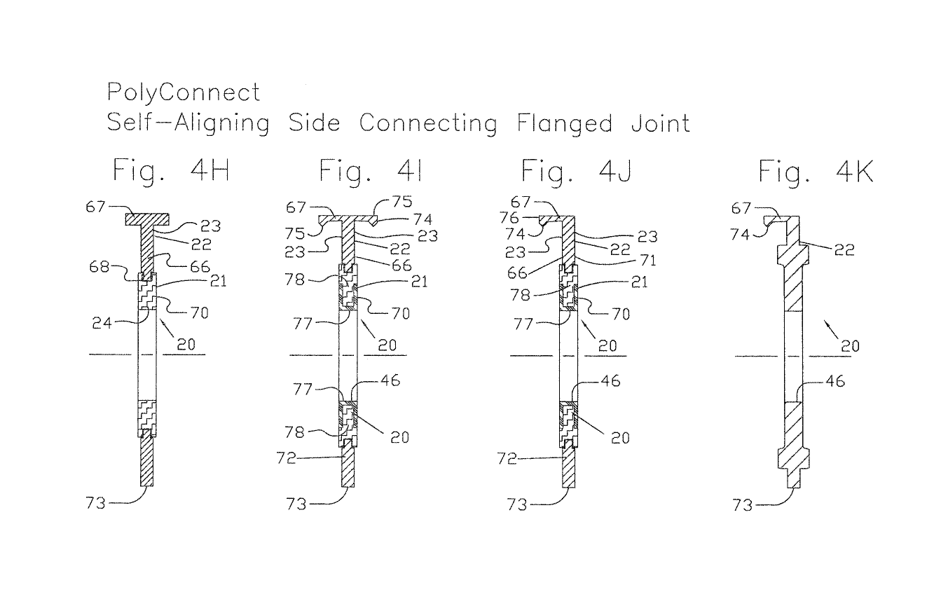

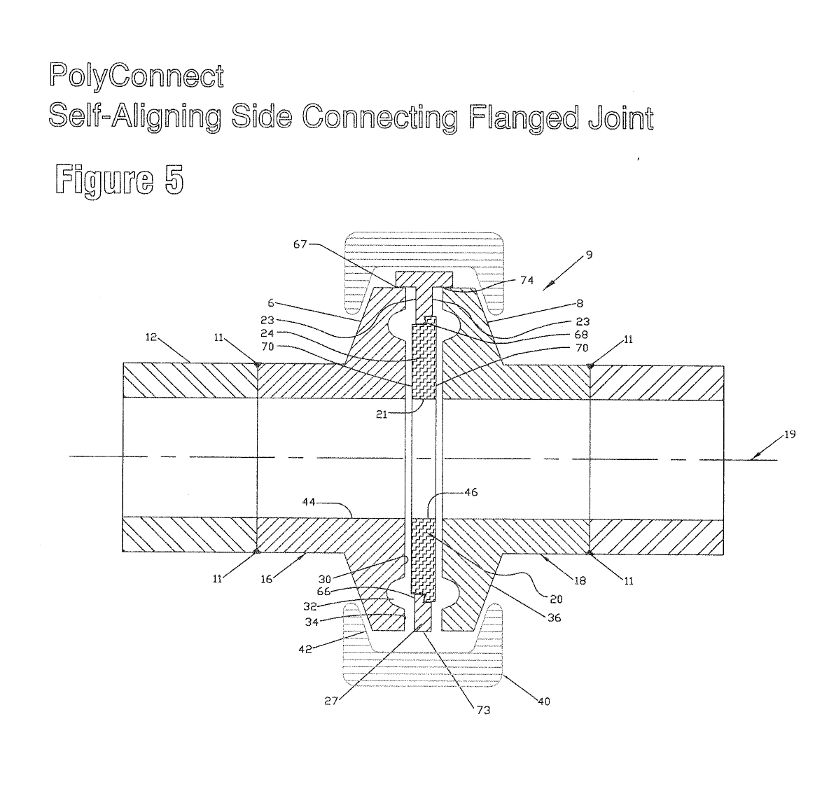

Reverting to FIG. 3A, open portion 73 is sized such that the pipe flanges do not have to be separated or pried apart unduly to insert 73 therebetween, and alignment rim 67 is sized sufficient to provide alignment and attachment 74 by impinging against pipe flanges 6 and 8, or the alignment rim can be slightly greater than the outside diameter of flanges 16 and 18, thereby permitting the flanges to be slid into the open, thin cylindrical recesses on generally proximate 23, each recess being bounded on its cylindrical side by rim 67 and on one cylindrical end by one of the axial surfaces 23 of ring 22. As a result, receipt of the flanges 16 and 18 within alignment ring 22 aligns the flanges 16, 18 and ring 22 in mutually coaxial relationship. The close match of the diameters of alignment rim 67 and the flanges 16, 18 virtually eliminates excessive lateral play or gasket misalignment and permits the assembly of the flange joint system to be substantially self-aligning. The thickness of alignment rim 67 in the radial direction is preferably sufficient to afford the extension adequate strength but no so large that it interferes with the closure of clamp 40. The axial extent of rim 67 is sufficient to provide secure alignment of ring 22 and flanges 16, 18. As shown in FIG. 4, retaining ring 22 can further includes a retaining shoulder or lock through area to secure the seal, which FIG. 4 also shown an embodiment wherein alignment rim 67 is designed to contact and attach to only one pipe flange 76.

Sealing member 21 is composed of a deformable material, preferably one that is resiliently deformable. The radially innermost portion of member 21 is a sealing portion 24 that is substantially rectangular in cross-section. The opposed axial faces 70 of rectangular portion 24 sealingly abut inner face portions 30 of flanges 16 and 18 in the assembled joint system. Sealing member 21 further includes a sealing shoulder portion 68 that projects radially outward and has a shape that is complementary to that of retaining shoulder 66. Sealing shoulder portion 68 and retaining shoulder 66 are removably engaged.

Turning to FIG. 4: The shape of the inter-engaged retaining shoulder 66 and sealing shoulder portion 68 may take a number of forms. The right-angled step engagement depicted in FIG. 3A and in an expanded view in FIG. 4A, permits the sealing member 21 and retaining ring 22 to be easily separated by slipping the components apart. The right-angled configuration of FIG. 4A, wherein the engagement is provided by surfaces are all either parallel to the plane of the mating surface or perpendicular to both the mating surface and the radial direction of the gasket assembly, is preferred for embodiments in which sealing member 21 is composed of materials with relatively low compliance, such as plastics. Other, more complicated shapes, such as angulated steps, including the multiply angulated step engagement shown in FIG. 4B and the singly angulated step engagement shown in FIG. 4C, provide a more secure inter-engagement but result in a slightly more difficult removal that temporarily entails greater elastic deformation of sealing member 21. Such a configuration is particularly suitable for use with various rubber sealing materials. In other embodiments, the elastomeric seal is mechanically locked in place, as depicted in FIG. 4D wherein the alignment rim has a “T” shaped profile for engaging two flanges on either side. Other profiles and shapes to accommodate two flanges as known to the artisan can also be employed and are within the scope of the invention. FIG. 4E shows an embodiment similar to 4D only the alignment rim has an “L” shaped profile to accommodate only one flange. Again, other profiles and shapes to accommodate one flange as known to the artisan can also be employed and are within the scope of the invention. FIG. 4F depicts a mechanically locked seal engagement with an alignment rim portion that is “T” shaped in profile for interfacing with both pipe flanges and an intermediate cushioning member and a rigid seal surface located at the inside diameter.

Yet other embodiments have a shoulder structure 66 provides a mortise and mating tenon engagement, with a pliable seal member 68, or a rigid 77 and elastomeric or more flexible intermediate member 78 to provide memory and improved sealing efficiency, the rim 74 can align with an open fit, an interference fit with both pipe flanges 75 or interference with one pipe flange 76, as shown in FIGS. 4H, 4I and 4J.

The removability of member 21 from ring 22 allows assembly to be renewed by substitution of a new member 21, with ring 22 being reusable. Moreover, some embodiments of the invention permit the sealing member to be made relatively narrow in radial extent compared to the retaining ring. Such a configuration is beneficially used in systems operating at temperatures significantly above or below ambient temperature. In many such instances, the materials used for the sealing member are required to meet stringent operational requirements, including high chemical resistance and high retention of compliance at operating temperatures. In many systems seal materials are exposed to high-pressure gasses or steam, while in others, oils and various organic solvents present a severe challenge. However, many of the materials that satisfy these demanding performance requirements also have coefficients of thermal expansion (CTE) very different from the CTE's of metals typically used for the retaining ring the seals must engage. As a result, many existing seal systems are prone to failures that stem from differential thermal expansion. On the other hand, embodiments of the present gasket assembly wherein the relative amount of seal material is small are much less likely to fail for these reasons.

The flanges used on each side of joint 10 have substantially identical form, rather than having complementary mating male and female forms used in certain other known types of joints. Accordingly, there is great flexibility in constructing and modifying a piping system in which the pipes and associated valves and fittings are assembled with joints configured as provided by the present invention.

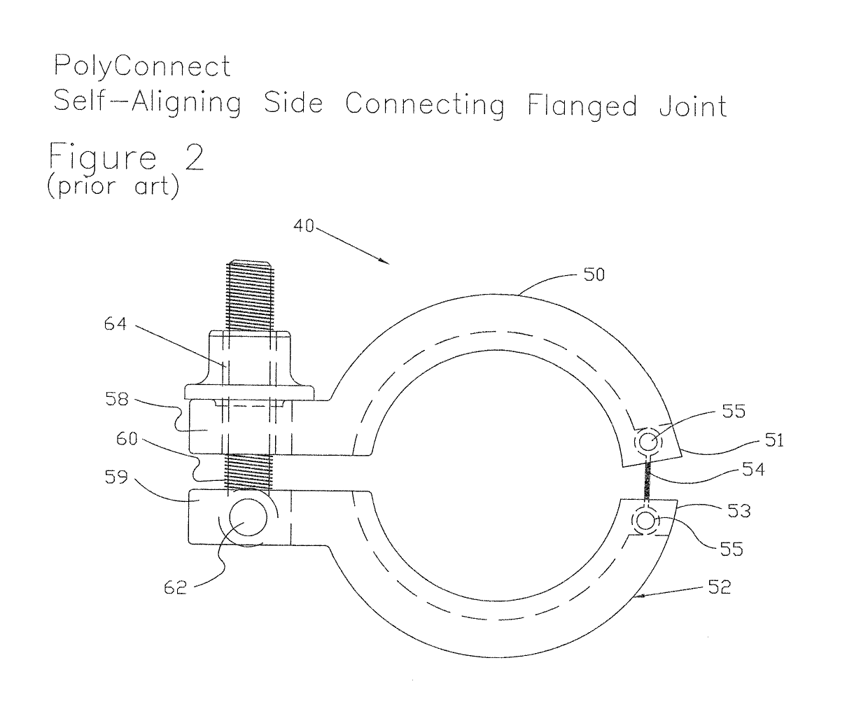

A clamp means, such as split-ring clamp 40 of the type depicted by FIG. 2, and having an inner circumferential surface with a V-shape and tapered surface portions 42, encircles and securingly engages correspondingly tapered, frustoconical outer sections 36 of flanges 16 and 18. The tapered surfaces of the clamp and flange are inclined at an angle .theta. as shown in FIG. 3, with .theta. preferably ranging from about 15 to 25.degree. More preferably, .theta. is about 20 .degree. Tightening the segments of clamp 40 imparts an axially directed force urging the flanges together. Flanged joints made using flanges having outside tapers, such as tapered surfaces 36 of flanges 16 and 18, in accordance with the present invention may be secured by clamps of a number of forms in addition to the type 40 depicted by FIG. 2. Any form of encircling clamp that produces an axially directed force applied to the tapered surface may be used. For example, linkage 54 and the nut and bolt fasteners 64, 60 may be replaced by other forms of lever engagement. The pivoting arrangement of linkage 54 may take alternate configurations. For example, linkage 54 and its attachments may be eliminated and ends 51 and 53 directly connected by a pivot pin. In still another form, linkage 54 and its attachments are replaced by a second nut and bolt fastener that is diametrically opposite and substantially similar to the first set used in the clamp of FIG. 2. Moreover, in the embodiment shown in FIGS. 2-3, both the outside tapered surfaces 36 of the flanges and the inside surface of clamp 40 have the shape of a frustoconical section of a right circular cone. In other embodiments of the invention, the clamping means comprises flanges and an encircling clamp either of which may have a taper that is other than the linear tapers shown in FIG. 3, such as curved tapers. Any such combination of shapes of the flanges and clamp interior that result in a clamping engagement that imparts a substantially uniform and axially directed force to the flanges may also be used.

The flanged joint provided herein may be used to join cylindrical pipes and tubes, e.g. those used in a process system. In addition, joints of the same form may be used to connect any combination of pipes, tubes, fittings, and other process equipment. The term “fittings” as used herein is to be understood as non-exclusively including adapters for connecting tubes of different sizes, ells for connecting pipes and tubes that are not collinearly directed, and fittings for connecting more than two pipes or tubes, such as tees and crosses. “Process equipment” as used herein non-exclusively comprises valves, filters, ports, reaction vessels, tanks, manifolds, pumps, and other components of a process system which are connected to place them in fluidic communication with other elements. As used herein and in the subjoined claims, the term “pipe” in relationship to a flanged joint is understood to include ordinary cylindrical pipe and tubing as well as any of the aforementioned fittings and process elements that are in fluidic communication with other elements through the joint. It is also to be understood that the axis of such fittings and process elements is the direction in which fluid enters or exits the element, which may or may not be a simple straight direction.

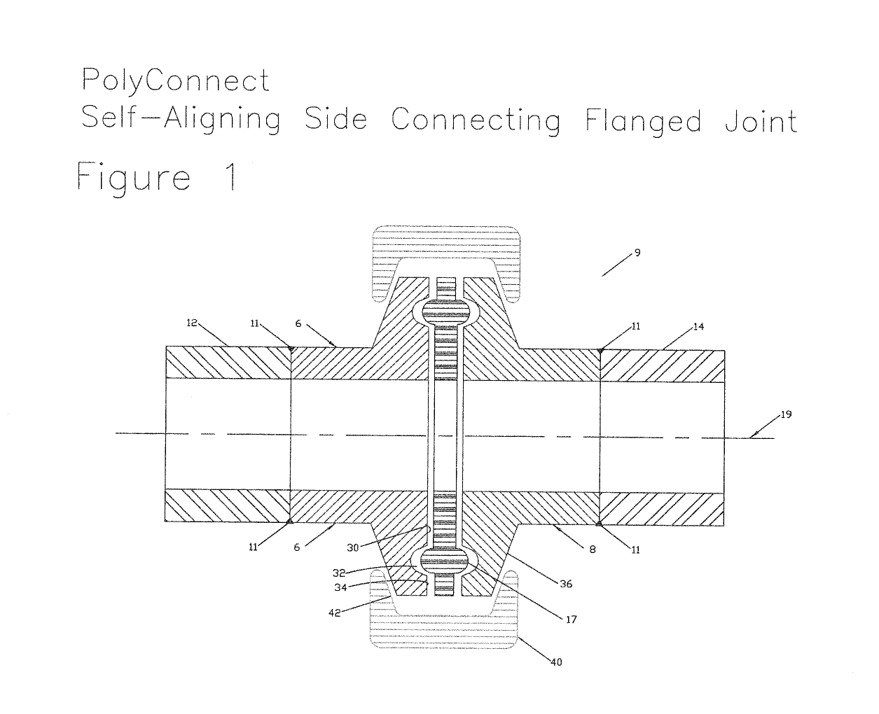

Many flanged joints used in existing process systems are easily modified to the configuration of the joint system of the present invention. In particular, joints using flanges having forms such as those of flanges 6 and 8 depicted in FIG. 1 are commonly used. These joints may be retrofitted using suitably configured and dimensioned gasket assemblies of the invention. One such implementation 9 is shown in FIG. 1. In one aspect, such a retrofit may be accomplished by suitable choice of the relative thicknesses of inner portion 24 of sealing member 21 and outer ring 27 and the optional provision of axially enlarged portion that can fit into the annular grooves 32 of retaining ring 27. Preferably, such an enlarged portion has a shape complementary that of grooves 32, thereby providing additional positive alignment of flanges 6, 8 and the gasket assembly.

In the various embodiments of the flanged joint of the invention, the axial approach of the flanges is positively limited by contact of mating surface portions 34 with the axially opposite sides 23 of retaining ring 22. The axial thickness of sealing portion 24 is selected to be slightly greater than that of ring 22, so that a requisite degree of compression of portion 24 is achieved when the flanges are engaged to the limit defined by retaining ring 22. As a result, dead volume in which any process fluid inadvertently leaked from the flange bore could become trapped or stagnant is substantially eliminated. The absence of such dead space is especially important in systems used for aseptic processing of foodstuffs, beverages, pharmaceuticals, or the like, intended for human or animal consumption. Preferably, the inner diameter of sealing member 21 is selected such that the assembled flange joint system has a smooth inner bore through its entire axial length. That is to say, when sealing member 21 is in its compressed state after normal installation in the joint of the invention, inner surface 46 of portion 21 and inner surface 44 of flanges 16 and 18 have substantially the same inside diameter and no gasket material intrudes into the bore. As a result, there is substantially no discontinuity at the transitions between flanges 16 and 18, and sealing member 21. In many prior art systems without the compression limit afforded by ring 22, overtightening and poor alignment frequently results in the extrusion of gasket material into the cylindrical bore of flanges in the joint region. A bore through the full joint with a smooth inner surface affords significant advantages. Flow of process fluid within the piping system is not impeded by unwanted turbulence. There are no projections that restrict draining of the piping system, even in horizontal runs. The configuration substantially eliminates the possibility that small pieces of extruded material, which are prone to becoming dislodged, would enter and contaminate the process stream. The smoothness is especially valuable in aseptic systems, since traps and dead zones are likely sites for harmful contamination and microbial activity. Furthermore, the retaining ring also provides protection against blowout of the sealing member under extreme overpressure conditions within the piping system.

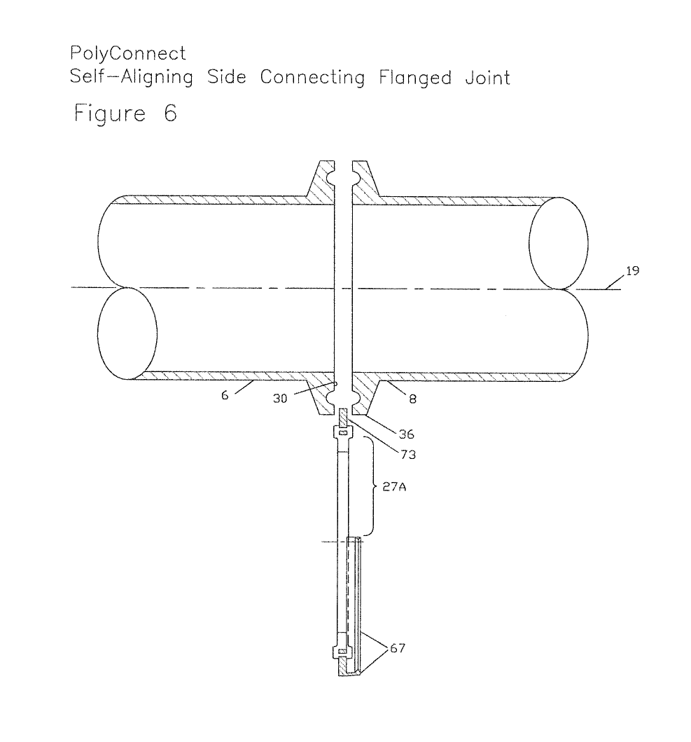

FIG. 6 depicts how the open portion of the retaining ring area and how it allows the assembly to be completed without the need to exaggerate the separation of the pipe flanges even under the closest fitting condition. It is most desirable for the pipe flanges to be installed in plants and on skids as close together as possible. The invention enables the processor to achieve ideal assembly conditions, which are tight fit toleranes on face-to-face dimensions of pipe flanges. A wide variety of materials are suitable for the components of the present joint system. In general, the materials must have mechanical and chemical properties that remain compatible with the conditions they are likely to encounter during their intended useful lifetime in a given process apparatus, with an acceptable margin of safety for process excursions and material variability. In particular, materials exposed to the process stream must be chemically stable, and the mechanical properties must be adequate for the joint to maintain its integrity during the joint lifetime.

The flanges are preferably composed of metal or metal alloys, including non-exclusively steel, copper, aluminum, brass, and nickel. Preferred alloys for the flanges include austenitic and ferritic stainless steels, Ni-base superalloys, monel, and inconel. Many of these alloys afford improved corrosion resistance and acceptable high temperature properties. Optionally, at least part of the flange mating surfaces or the flange bore are coated, plated, hardfaced, or otherwise beneficially treated with suitable substances to improve any of their properties. Ideally, the flanges are composed of alloy that is easily processed or machined as needed to provide the required configuration, but has sufficient hardness and strength to resist scratching, wear, or mechanical degradation during assembly and operation, and especially during servicing. The flanges must be amenable to attachment to other piping systems by the desired means, such as the aforementioned welding, brazing, or soldering. Most important, the flanges must be made of material that is chemically compatible with the process fluid conveyed therethrough and withstand normal operating temperatures and pressures with an adequate safety margin.

The retaining ring is preferably composed of metal, metal alloy, or hard plastic or rubber of sufficient strength and modulus to render it substantially rigid. More preferably, the ring is composed of the same material used to construct the flanges.

A wide range of materials are suitable for constructing the sealing member, which is preferably composed of deformable elastomeric, polymeric, composite or fibrous materials, or soft metal. Such materials include natural, synthetic, and silicone-based rubbers. Frequently used rubber materials include ethylene propylene (EPDM), ethylene acrylate, polychloroprene (NEOPRENE®), nitrile (Buna), fluorocarbon (FKM, VITON® and Kel-F), silicone, and fluorosilicone rubbers. Other polymeric materials are also used, such as PTFE (TEFLON®), CTFE, PFA, and PEEK. Composite materials such as polysteel, which includes stainless steel powder in a PTFE matrix, may be used, despite being less compliant. The sealing member must be sufficiently deformable to achieve a reliable seal. More preferably, the material is highly compliant and resiliently deformable and does not take a “set” as a result of creep or other mechanical degradation during extended storage or operation. Most preferably, the sealing member is an elastomer or polymer. Suitable sealing members preferably exhibit durometer ratings in the range of about 70 to 90 Shore A. Other desired characteristics of sealing materials include low cost, ease of fabrication, and lack of significant environmental concerns. It is further preferred that no other sealants be required, since many known sealants would contaminate the process stream or cause degradation of typical elastomers.

Having thus described the invention in rather full detail, it will be understood that such detail need not be strictly adhered to but that various changes and modifications may suggest themselves to one skilled in the art, all falling within the scope of the present invention as defined by the subjoined claims.

What is claimed is:

1. A gasket assembly comprising
(a) a sealing member;
(b) a retaining ring having an outer periphery and an inner periphery, said inside periphery being coupled to said sealing member; and
(c) an alignment rim disposed outwardly from the outer periphery of said retaining ring, said alignment rim extending continuously along only a portion of said outer periphery.

2. The gasket assembly of claim 1 wherein the retaining ring having a substantially constant cross sectional thickness from said outer periphery to said inner periphery.

3. The gasket assembly of claim 2 wherein said alignment rim extends along about 40 to about 60% of the outer periphery.

4. The gasket assembly of claim 3 wherein said alignment rim extends along about 49% of the outer periphery.

5. The gasket assembly of claim 3 wherein said alignment rim has profile that is “T” shaped or “L” shaped.

6. The gasket assembly of claim 3 wherein the outer periphery of the retaining ring that does not comprise the alignment rim is an open portion extending continuously along about 40 to about 60% of the outer periphery.

7. The gasket assembly of claim 1 wherein said sealing member, said retaining member and said alignment ring are formed from the same material of construction and comprise a single unitary construction.

8. The gasket assembly of claim 7 wherein said material of construction is a polymeric.

9. The gasket assembly of claim 8 wherein said material of construction is selected from the group consisting of PTFE, PFA, polysteel, Buna, EPDM, silicone, FKM, PEEK, and CTFE materials, and combinations thereof.

10. A flanged joint system connecting first and second pipes disposed along a common axis, comprising:
a) a first flange terminating said first pipe and a second flange terminating said second pipe, each of said flanges being generally circular and having a flange outside diameter and a mating surface, said pipes being oriented such that said mating surfaces are substantially perpendicular to said common axis and in facing, parallel relationship;
b) a gasket assembly comprising:
(i) an outer annular, substantially rigid retaining ring having opposed axial surfaces abutting at least a portion of said mating surfaces, said retaining ring having 1) an alignment rim encircling about 40 to about 60% of the outside periphery of said ring and extending axially from at least one side of said outer periphery, and 2) an open portion comprising the remaining about 60 to about 40% of said outer periphery of said ring, said open portion sized sufficient to allow it to slide into place between the first and second flanges, and 3) a retaining shoulder projecting radially inward, said alignment rim being sized to slippably receive said outside diameter of at least one flange on one side of said retaining ring;
(ii) an inner deformable annular sealing member having a radially inner annular portion having a rectangular cross-section and sealing surfaces on opposed axial sides of said rectangular portion, and an encircling sealing shoulder portion that projects radially outward, said sealing shoulder portion being shaped to receive said retaining shoulder and being removably engaged therewith; and said gasket assembly being interposed between said flanges and aligned coaxially therewith by receipt of said outside diameter within said alignment rim;
c) a clamp means for urging said flanges together axially, whereby said deformable annular sealing member is compressed to a preselected extent, the compression being restricted by abutment of said axial surfaces of said retaining ring with said mating surfaces of said flanges; and wherein said retaining shoulder and said sealing shoulder portion provide an angulated step engagement.

11. The flanged joint system of claim 10 wherein said inner deformable annular sealing member is secured to said retaining ring by mechanical bonding or chemical bonding or both.

12. A flanged joint system as recited by claim 10, wherein said inner deformable annular sealing member is resiliently deformable.

13. A flanged joint system as recited by claim 10, wherein said inner deformable annular sealing member is composed of an elastomer.

14. A flanged joint system as recited by claim 10, wherein said inner deformable annular sealing member is composed of a material selected from the group consisting of PTFE, PFA, polysteel, Buna, EPDM, silicone, FKM, PEEK, and CTFE materials, or combinations thereof.

15. A flanged joint system as recited by claim 10, wherein said inner deformable annular sealing member is composed of a composite material comprising a polymer.

16. A flanged joint system as recited by claim 10, wherein said retaining ring is composed of metal or a substantially rigid plastice

17. A flanged joint system as recited by claim 10, wherein said flanges have tapered outer sections and said clamp means comprises a split-ring clamp having an inner circumferential surface with tapered surface portions that encircle and securingly engage said tapered outer sections.

18. A flanged joint system as recited by claim 10, wherein said retaining ring is composed of a substantially rigid plastic.

19. A flanged joint system as recited by claim 11, wherein said clamp means comprises at least one clamp.

20. A flanged joint system as recited by claim 18, wherein said flanges have tapered outer sections and said clamp means comprises a split-ring clamp having an inner circumferential surface with tapered surface portions that encircle and securingly engage said tapered outer sections.
